(19) United States
(12) Patent Application Publication
(10) Pub. No.: US 2005/0098732 A1
(43) Pub. Date: May 12, 2005

(54) Flat-panel detector utilizing electrically interconnecting tiled photosensor arrays

(75) Inventors: Jian-Qiang Liu, Campbell, CA (US); Xiao-Dong Sun, Fremont, CA (US)

Correspondence Address: The Sherr Patent Firm, PLLC;Suite 550, 11921 Freedom Drive, Reston, VA, 20190, US

(73) Assignee: LS Technologies, Inc.

(21) Appl. No.: 10/984,740

(22) Filed: Nov. 10, 2004

Related U.S. Application Data
(60) Provisional application No. 60/518,962, filed on Nov. 10, 2003.

(51) Int. Cl. G01T 1/20

(52) U.S. Cl. 250/370.11

(57) ABSTRACT

A detector which may include the following: A flat base plate. An (N×M) array of detector tiles attaching on to the base plate, each said detector tile comprising an array of photo-sensors fabricated on a substrate having necessary circuitry. A plurality of data finger tiles attaching on to the said base plate, each data finger tile comprising a plurality of data lines. A plurality of scan finger tiles attaching on to the said base plate, each scan finger tile comprising a plurality of scan lines. An electrical interconnection network interconnecting the adjacent said detector tiles on their front surfaces. An electrical interconnection network connecting N units of the said detector tiles to a plurality of the said data finger tiles. An electrical interconnection network connecting M units of the said detector tiles to a plurality of the said scan finger tiles.

Priority is claimed to U.S. Provisional Patent Application No. 60/518,962, filed in the U.S. Patent and Trademark Office on Nov. 10, 2003, which is hereby incorporated by reference.

### BACKGROUND

Digital X-ray flat-panel detectors (FPD), based on the combination of amorphous silicon thin film transistor and photodiode with X-ray scintillators technology, are being developed. These digital detectors, in general, have much better dynamic range and detection quantum efficiency (DQE) than X-ray films. Flat panel X-ray detectors are increasingly used in X-ray imaging for medical and industrial non-destructive diagnosis applications. A large size flat panel X-ray detector may be used to image comparable sized objects, such as a human body. A single large sized panel of X-ray detector (e.g. 40 cm by 40 cm) may be used for these applications. Such a large panel detector may be made with special, frequently expensive facilities with low yield. As results, the cost of the large area X-ray detectors may be high and may therefore limit applications.

Making large-size flat-panel X-ray detectors requires correspondingly large semiconductor processing equipment. For example, in order to make a 40×40 cm² flat-panel detector, the glass substrate used may need to be at least ˜45×45 cm². The fabrication equipment for such a substrate (e.g. lithography stepper, PECVD thin film deposition system, and reactive ion etcher (RIE)) may need to have stages or deposition chambers larger than the substrate size. The cost associated with maintaining and operating such a fabrication facility or equipment, may be relatively high. In addition, the yield of making large size detector panel is relatively low, since defects on a small-localized region of the large panel can ruin the whole panel during the manufacturing process or in the operation of the detector. Such a large size process may not be flexible. For example, to increase the size of a X-ray detector, a complete line of processing equipment may have to be upgraded/replaced.

### SUMMARY

Embodiments relate to a large area imaging detector of high energy radiations or particles such as X-ray, Gamma ray and photons. The detector may include the following: A flat base plate. An (N×M) array of detector tiles attaching on to the base plate, each detector tile includes an array of photo-sensors fabricated on a substrate having necessary circuitry. A plurality of data finger tiles attaching on to the said base plate, each data finger tile includes a plurality of data lines. A plurality of scan finger tiles attaching on to the said base plate, each scan finger tile includes a plurality of scan lines. An electrical interconnection network interconnecting the adjacent said detector tiles on their front surfaces. An electrical interconnection network connecting N units of the said detector tiles to a plurality of the said data finger tiles. An electrical interconnection network connecting M units of the said detector tiles to a plurality of the said scan finger tiles.

Embodiments relate to a method of making a large area imaging detector of high energy radiation or particles such as X-ray, Gamma ray and photons. The method may include the following: Arranging an (N×M) array of detector tiles on to a flat base plate into a repetitive and regular pattern, each said detector tile comprising an array of particle detector cells fabricated on a substrate having necessary circuitry. Arranging a plurality of data finger tiles on to the said flat base plate into a repetitive and regular pattern, each said data finger tile comprising a plurality of data lines. Arranging a plurality of scan finger tiles on to the said flat base plate into a repetitive and regular pattern, each said scan finger tile comprising a plurality of scan lines. Fixing the detector tiles, data finger tiles and scan finger tiles to the said base plate while maintaining the said regular patterns. Forming an electrical interconnection network connecting the adjacent said tiles on their front surfaces. Protecting the electrical interconnection network and said tiles with a passivation coating.

### DRAWINGS

FIG. 1a through 1c illustrate example building blocks of electrically interconnected structures for a large-size light imaging detector, in accordance with embodiments.

FIG. 2 shows an example assembled integrated large-size light-imaging detector with four detector tiles, in accordance with embodiments.

FIG. 3 illustrates example key fabrication process steps, including tiling and interconnection, for a single integrated larger size flat panel photon detector, in accordance with embodiments.

### DESCRIPTION

Embodiments relate to a system of digital X-ray detectors for electrically interconnecting and integrating smaller sized detector panels into low cost larger sized detector panels to detect X-ray and other high-energy particles.

Embodiments relate to a concept, components, and design of advanced larger integrated X-ray flat panel detectors (FPD). Tiling and electrically interconnecting smaller detector panels on a wafer or glass substrate may yield large size X-ray detector panels. Such a method and process may solve the aforementioned problems associated with making a single piece large X-ray detector panel, and may afford the following advantages: The cost of facilities in making small size X-ray detectors may be much lower, due to the higher yield and low cost of the smaller panels. This may result in low cost X-ray detectors. The defects from a localized panel module may be erased, by simply changing the module while keeping the rest of good modules intact in the detector panel. Combining and interconnecting more small size X-ray panels together may increase the size of the large panel detectors.

The sensor/detector wafers or substrates that may be tiled and interconnected together into a larger detector wafer or glass substrate may include various silicon based light sensors, such as photodiode array, CCD, CMOS sensors, or flat-panel light sensors, such as amorphous silicon or polysilicon based thin-film photodiode or photosensors array for advanced X-ray and gamma ray detection.

A low-profile interconnection processes that may connect individual module electronically together include photolithography patterning, direct wire printing, wire bonding, or bonding of pre-fabricated connector arrays.

A common layer of scintillator may be applied to the tiled and interconnected array larger detector wafer/substrate before being sealed/packaged into the large area X-ray or gamma ray detector. By replacing scintillators with photoconductors such as Selenium, a similar principle of making integrated larger photon detectors by tiling and interconnecting smaller detector/sensor units or substrates, such as thin film transistors (TFT) array, can also be applied to direct FPD for advanced X-ray and gamma ray detection.

The integrated large FPD may be used in an X-ray or gamma ray imaging system for image detection or diagnosis, including medical imaging, computed tomography (CT), non-destructive evaluation (NDE), cargo/luggage security/food inspection applications.

A similar principle of making integrated larger photon detectors by tiling and interconnecting smaller detector/sensor units or substrates for X-ray can also be applied to other types of detectors with larger panel for high energy particles such as electron, positron, deep UV light.

Digital X-ray flat panel detectors (FPD) are increasingly used in medical imaging and industrial non-destructive diagnosis. The existing digital X-ray FPD technology may be divided into the two basic categories of direct and indirect conversion. In direct conversion X-ray FPD (e.g., manufactured by Hologic Inc.), Selenium (Se) photoconductor is used to directly convert X-ray photons into free electrons, which are detected by the underlining thin film transistor (TFT) panel. Although Selenium based detectors may have a relatively high Modular Transfer Function (MTF), they may suffer from low X-ray quantum efficiency and low absorption, particularly for X-ray with photon energy >40 keV. It may also have a high image lag and low detection quantum efficiency (DQE) at low spatial frequencies.

Some indirect conversion detectors use either CsI:Tl or Gd₂O₂S as X-ray scintillator and amorphous silicon photodiode array as light sensor. Scintillators may be deposited onto a photodiode array, which convert the X-rays to electrons through visible photon intermediate. The photodiode array is placed on TFT panel. Indirect conversion detectors have relatively high quantum efficiency (for X-ray photons above 40 keV), relatively low image lag, and relatively high DQE at low spatial frequencies. However, the some indirect X-ray FPD may suffer from low MTF and low DQE at a high spatial frequency.

Both direct and indirect FPD may take the modular approach, in accordance with embodiments. By building a single integrated large panel detector using electrically interconnected tiles of smaller detectors, data fingers and scan fingers, the manufacturing costs will be substantially reduced and the yield substantially increased. In embodiments, a similar principle of forming larger integrated detector panel by electrically interconnecting smaller panels may also be applied to other photon detectors (e.g. CCD (charge coupling device) and CMOS sensors).

A large size flat-panel X-ray detector may be divided, based on functions and locations, into various functional areas Accordingly, the X-ray detector may inclue a scan fingers area, a data fingers area, a corners area, and a photosensitive pixel array area. Other areas may also be included in the X-ray detector. The scan line and data line fingers may be located at the edge of the panel. The detector pixel array may be located in the center region of the panel. In embodiments, a feature of these pixilated sensor areas is that they all have repetitive patterns. For example, the pixel array may include N×M identical single pixels, a scan finger area may include N lines of scan fingers, which may be grouped into several identically laid-out finger groups. This repetitive nature of large size detector may allow for assembling large X-ray detectors using small tiles, in accordance with embodiments.

In accordance with embodiments, a large flat panel imaging-detector is assembled on a substrate from three types of repetitive tiles that are electrically interconnected. Three example types of tiles are photo sensor tiles, scan finger tiles, and data finger tiles. The tiles form a regular, repetitive pattern with well-defined tile-to-tile distances. The aforementioned large flat panel detector may include a single common layer of X-ray scintillator on the whole tiled detector arrays to form a single integrated large X-ray detector.

In accordance with embodiments, a digital detector array (e.g. with 2048×2048 pixels) may be assembled from four sensor arrays (e.g. each contains 512×512 pixels) using a 2×2 tile structure. The example 2048 lines of scan fingers can be assembled from 8 pieces of 256 lines scan finger tile modules. Likewise, the 2048 lines of data fingers may be assembled from 8 pieces of 256 lines data finger tile modules. Since these data finger tiles and scan finger tiles have areas that are smaller than half of the detector tiles, one can make these tiles by using semiconductor equipment for much smaller wafers. For example, using 6″ diameter silicon wafer processing equipments, a 4″×4″ pixel tile can be fabricated and assembled into 8″×8″ (a 2×2 tiling array) or 12″×12″ (a 3×3 tiling array) or even larger detectors.

A tiled structure, in accordance with embodiments may be used to form indirect conversion digital X-ray detectors, which have separate X-ray scintillator layer and photosensitive imaging detector layer. The tiled structure may apply to direct conversion type of digital X-ray detectors that convert X-ray directly to photoelectrons, in accordance with embodiments. Since it is the most costly components in a digital flat-panel detector, the photosensitive imaging detector may be assembled from smaller tiles, in accordance with embodiments. The X-ray scintillator that is applied after the tiling, on the other hand, may be in the form of a continuous layer or sheet with uniform physical properties. In embodiments, the common layer of scintillator may be scintillators such as CsI:Tl film, or a sheet of a Gd₂O₂S doped with rare earth elements. By alignment and edge control of each tile, the gap between tiles can be made to be substantially close to the width of one or a finite number of pixel-size of the photo sensor array. The small and consistent gaps contribute to minimum lose of information at the gap. Image quality may be further improved by interpolating the missing pixel from neighboring pixels to the acquired image.

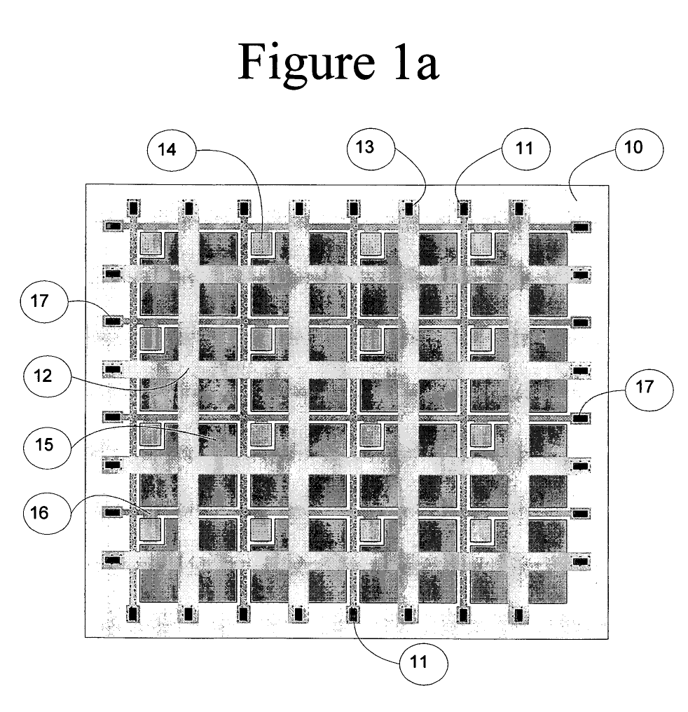

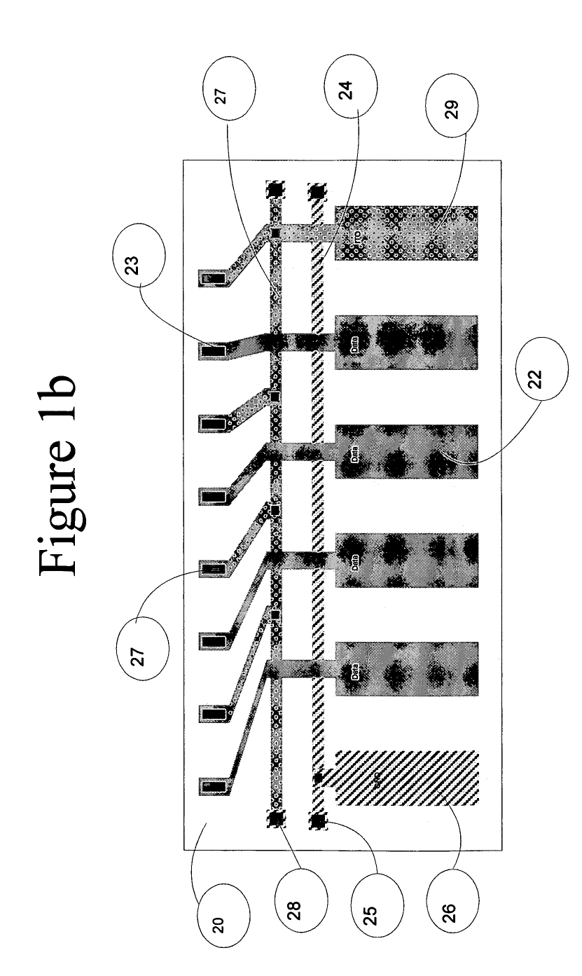

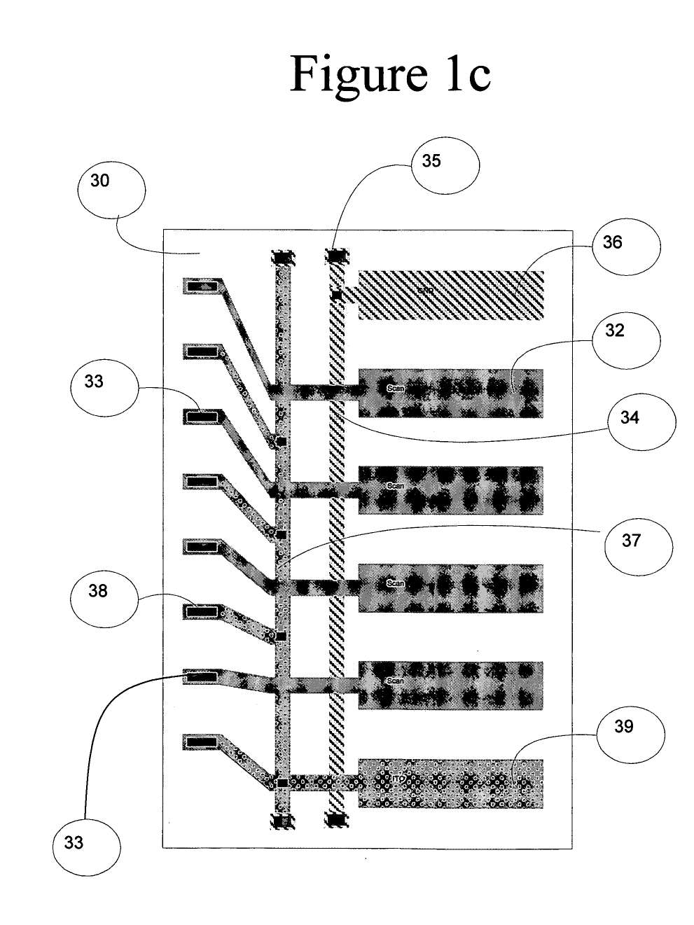

In embodiments, the building blocks of a large flat panel detector may include at least three types of tiles, as illustrated in example FIGS. 1a, 1b, and 1c. One type of tiles is the photodetector pixel array tile (e.g. FIG. 1a), another is data finger tile (e.g. FIG. 1b), the third type is scan finger tile (e.g. FIG. 1c). The pixel array tile may include a sensor substrate (10), data lines and edge connection pads (11), ITO (Indium Tin Oxide) common lines (12) and connection pads (13), thin-film-transistors (TFT) (14), photosensitive diode (15), scans lines (16) and edge connection pads (17). The TFT and photosensitive diode can be made from amorphous or polycrystalline silicon.

The data finger tile may include substrate (20), data line contact fingers (22) and data line edge connection pads (23), electric ground line (24), edge connection pads (25) and contact fingers (26) of the ground, ITO common lines (27), edge connection pads (28), and contact fingers (29) of the ITO common.

The scan finger tile may have a similar function as data finger tile and a similar layout. The scan finger tile may include substrate (30), scan line contact fingers (32) and scan line edge connection pads (33), electric ground line (34), edge connection pads (35) and contact fingers (36) of the ground, ITO common lines (37), edge connection pads (38) and contact fingers (39) of the ITO common. Additionally, corner tiles may be used to connect the grounding lines on scan and data fingers.

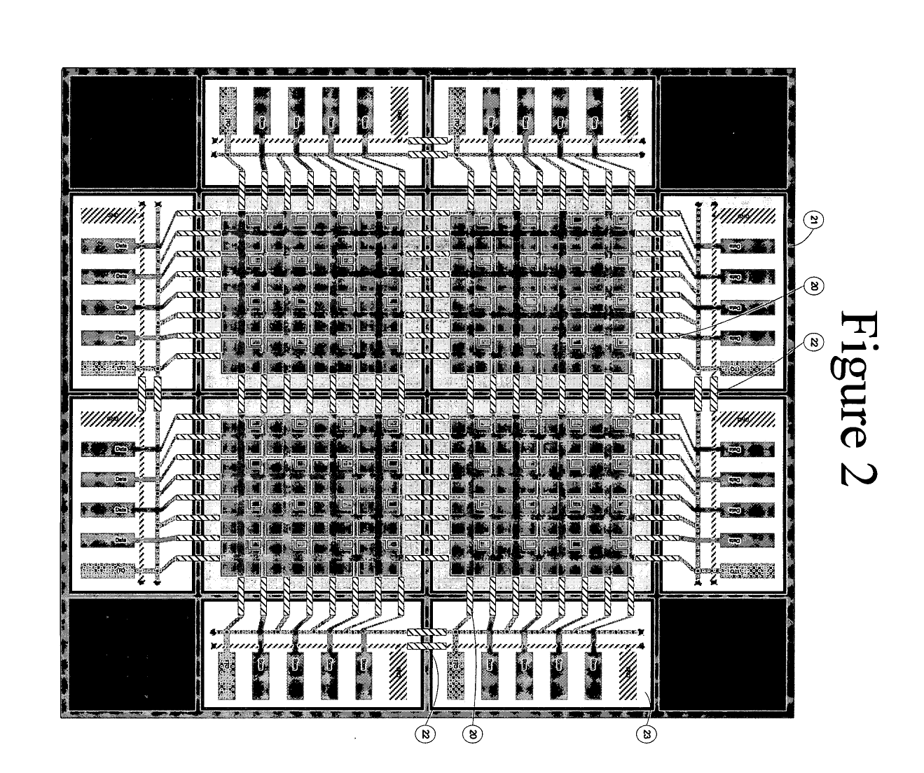

An example fabrication process of interconnected detector tiles, in accordance with embodiments, is as follows: Tiles may be electrically connected together to form a functional light-imaging device and may be tested for performance. Tiles may be separated and defective tiles may be scraped. Qualified tiles may then be assembled together to form a fully functional light-imaging detector as illustrated in example FIG. 2.

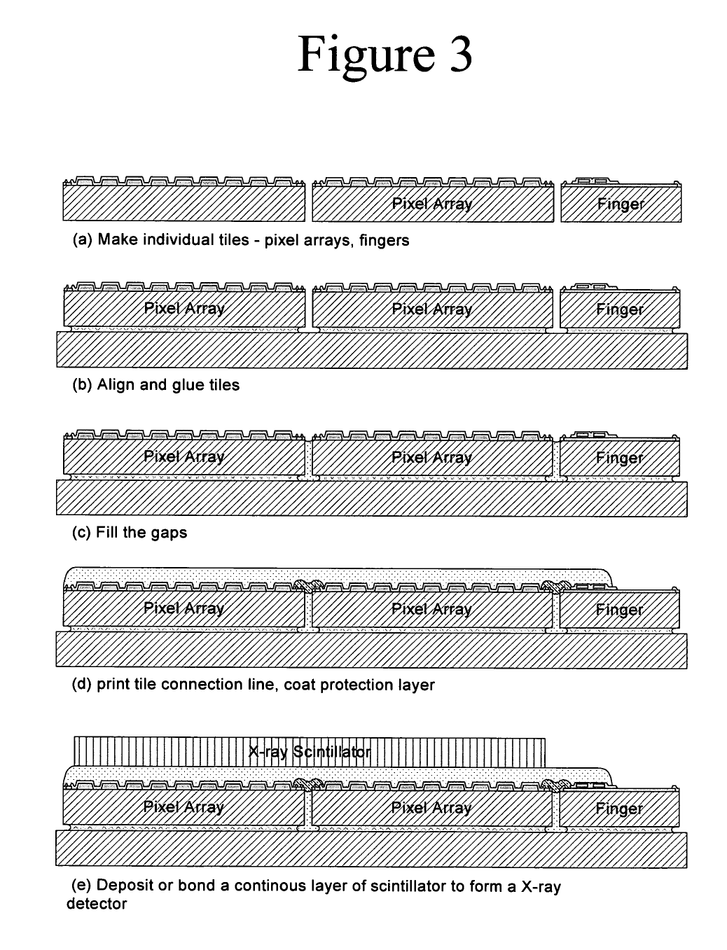

A tiling process, as illustrated in example FIG. 3, in accordance with embodiments is as follows: Functional tiles may be placed on a substrate. The functional tiles may be made of the same type of glass as the sensor and finger tiles or of a different material (e.g. ceramic or metal, or composite polymers). The substrate thermal expansion coefficient (CTE) may be matched to the CTE of the tiles. Tiles may be aligned along scan and data line directions. Precision adjustments may be made so the gap between tiles are within an adequate tolerance. Each tile may be secured (e.g. using fast action glue or light curing glue). Epoxy may be dispensed to fill the gaps between tiles. The panel may be let to set under appropriate temperature environment (e.g. until Epoxy is fully cured). An edge connection pad may be printed to connect each tile electrically. A passivation and protective coat may be coated on the connection pad. The passivation layer may be cured. A continuous sheet of pre-made X-ray scintillator may be bonded or deposited directly on the scintillator film on top of the assembled flat-panel imager to form the X-ray array sensor. The X-ray array sensor and bond electronic scan/data modules may be sealed and packaged to the finger. The other modules may be attached to finish the X-ray detector assembly

In embodiments, in addition to the amorphous silicon process, the tiles may be made using other semiconductor process (e.g. a CMOS process). CMOS image sensor arrays may be made on 4″˜12″ wafers and assembled together to form a large size flat-panel detector. Such detectors may be used for many applications including medical imaging, industrial non-destructive imaging, security inspection at port etc. In embodiments, multiple CCD sensors can also be interconnected to form a large size flat panel photon detector.

The foregoing embodiments (e.g. flat-panel detector utilizing electrically interconnecting tiled photosensor arrays) and advantages are merely examples and are not to be construed as limiting the appended claims. The above teachings can be applied to other apparatuses and methods, as would be appreciated by one of ordinary skill in the art. Many alternatives, modifications, and variations will be apparent to those skilled in the art.

1. A large area imaging detector of high energy radiations or particles such as X-ray, Gamma ray and photons comprising:
a flat base plate;
an (N×M) array of detector tiles attaching on to the said base plate, each said detector tile comprising an array of photo-sensors fabricated on a substrate having necessary circuitry;
a plurality of data finger tiles attaching on to the said base plate, each data finger tile comprising a plurality of data lines;
a plurality of scan finger tiles attaching on to the said base plate, each scan finger tile comprising a plurality of scan lines;
an electrical interconnection network interconnecting the adjacent said detector tiles on their front surfaces;
an electrical interconnection network connecting N units of the said detector tiles to a plurality of the said data finger tiles;
an electrical interconnection network connecting M units of the said detector tiles to a plurality of the said scan finger tiles.

2. The large area digital imaging detector recited in claim 1 wherein N being an integer greater or equal to 1.

3. The large area digital imaging detector recited in claim 1 wherein M being an integer greater or equal to 2.

4. The large area digital imaging detector recited in claim 1 wherein a layer of scintillating material being placed atop of the said detector tiles.

5. The large area digital imaging detector recited in claim 1 wherein the said detector tiles further comprising a plurality of data lines, scan lines, ITO common lines, ground lines and edge connection pads.

6. The large area digital imaging detector recited in claim 1 wherein the said data finger tiles further comprising of ITO common lines, ground lines, edge connection pads and contact fingers.

7. The large area digital imaging detector recited in claim 1 wherein the said scan finger tiles further comprising of ITO common lines, ground lines, edge connection pads and contact fingers.

8. The large area digital imaging detector recited in claim 1 wherein the said detector cells having a grid spacing of 5 μm to 5 mm; or preferably of 10 μm to 1 mm.

9. The large area digital imaging detector recited in claim 1 wherein the said detector cells being photodiode cells.

10. The large area digital imaging detector recited in claim 1 wherein the said detector cells being CCD cells.

11. The large area digital imaging detector recited in claim 1 wherein the said detector cells being CMOS sensor cells.

12. The large area digital imaging detector recited in claim 4 wherein the said scintillating material being in powder forms.

13. The large area digital imaging detector recited in claim 4 wherein the said scintillating material being in the form of a coating or thin film.

14. The large area digital imaging detector recited in claim 4 wherein the said scintillating material being a film of CsI:Tl.

15. The large area digital imaging detector recited in claim 4 wherein the said scintillating material being rare earth doped Gd₂O₂S.

16. A method of making a large area imaging detector of high energy radiation or particles such as X-ray, Gamma ray and photons comprising the following steps:
arranging an (N×M) array of detector tiles on to a flat base plate into a repetitive and regular pattern, each said detector tile comprising an array of particle detector cells fabricated on a substrate having necessary circuitry;
arranging a plurality of data finger tiles on to the said flat base plate into a repetitive and regular pattern, each said data finger tile comprising a plurality of data lines;
arranging a plurality of scan finger tiles on to the said flat base plate into a repetitive and regular pattern, each said scan finger tile comprising a plurality of scan lines;
fixing the said detector tiles, data finger tiles and scan finger tiles to the said base plate while maintaining the said regular patterns;
forming an electrical interconnection network connecting the adjacent said tiles on their front surfaces;
protecting the said electrical interconnection network and said tiles with a passivation coating;

17. The method recited in claim of 16 wherein N being an integer greater or equal to 1.

18. The method recited in claim of 16 wherein M being an integer greater or equal to 2.

19. The method recited in claim of 16 wherein a layer of scintillating material being placed atop of the said detector tiles.

20. The method recited in claim of 16 wherein the said detector tiles further comprising a plurality of data lines, scan lines, ITO common lines, ground lines and edge connection pads.

21. The method recited in claim of 16 wherein the said data finger tiles further comprising of ITO common lines, ground lines, edge connection pads and contact fingers.

22. The method recited in claim of 16 wherein the said scan finger tiles further comprising of ITO common lines, ground lines, edge connection pads and contact fingers.

23. The method recited in claim of 16 wherein the said detector cells having a grid spacing of 5 μm to 5 mm; or preferably of 10 μm to 1 mm.

24. The method recited in claim of 16 wherein the said detector cells being amorphous silicon photodiode cells.

25. The method recited in claim of 16 wherein the said detector cells being CCD cells.

26. The method recited in claim of 16 wherein the said detector cells being CMOS active pixel sensor cells.

27. The method recited in claim of 19 wherein the said scintillating material being in powder forms.

28. The method recited in claim of 19 wherein the said scintillating material being in the form of a coating or thin film.

29. The method recited in claim of 19 wherein the said scintillating material being a film of CsI:Tl.

30. The method recited in claim of 19 wherein the said scintillating material being rare earth doped Gd₂O₂S.
